(19) United States
(12) Patent Application Publication
(10) Pub. No.: US 2006/0202435 A1
(43) Pub. Date: Sep. 14, 2006

(54) Drill chuck with shield sleeve

(75) Inventors: Gunter Horst Rohm, Sontheim (DE); Anno Lico Rohm, Sontheim (DE)

Correspondence Address: THE FIRM OF KARL F ROSS, 5676 RIVERDALE AVENUE, PO BOX 900, RIVERDALE (BRONX), NY, 10471-0900, US

(73) Assignee: ROHM GmbH

(21) Appl. No.: 11/347,818

(22) Filed: Feb. 3, 2006

(30) Foreign Application Priority Data
Feb. 14, 2005 (DE) 102005006781.6
Mar. 16, 2005 (DE) 102005012534.4

(51) Int. Cl. B23B 31/12

(52) U.S. Cl. 279/62

(57) ABSTRACT

A chuck has a drive shaft extending along and rotatable about an axis and an adjacent nonrotatable housing part adjacent the drive shaft. A chuck body fixed to the shaft and formed with a plurality of guides holding respective jaws shiftable between closely spaced inner positions and widely spaced outer positions. An adjustment sleeve surrounding the body and coupled to the jaws is rotatable about the axis relative to the body to shift the jaws between their positions. A coupling sleeve engaged between the housing part and the adjustment sleeve can shift between a coupled position rotationally locking the adjustment sleeve to the housing part and a decoupled position permitting rotation about the axis of the adjustment sleeve relative to the housing part. A shield sleeve generally rotationally fixed on the housing part coaxially surrounds at least a portion of the adjustment sleeve and chuck body.

### FIELD OF THE INVENTION

The present invention relates to a chuck. More particularly this invention concerns a drill chuck typically used to hold a drill bit or the like on a power-drill unit.

### BACKGROUND OF THE INVENTION

A chuck is known from EP 0,716,896 having a drive shaft extending along and rotatable about an axis and a housing part adjacent the drive shaft and generally nonrotatable about the axis. A chuck body fixed to and rotatable with the shaft is formed with a plurality of guides holding respective jaws shiftable between closely spaced inner positions and widely spaced outer positions. An adjustment sleeve surrounding the body and coupled to the jaws is rotatable about the axis relative to the body to shift the jaws between their positions. A latch between the housing part and the adjustment sleeve can shift between a coupled position for rotationally locking the adjustment sleeve to the housing part and a decoupled position for rotation about the axis of the adjustment sleeve relative to the housing part. Typically a torque decoupler is provided for decoupling the latch from the chuck body when, in the coupled position, a torque exerted between the adjustment sleeve and the chuck body exceeds a predetermined limit.

Thus with this system the latch is shifted into the coupled position so that the motor of the drive unit connected to the shaft can be used to rotate the chuck body in the appropriate direction to tighten or loosen the chuck. When the jaw reach an solid inner position bearing on a tool or their outer position, the decoupler will respond to prevent damage to the chuck.

The drill with such a chuck has a sensor that automatically prevents operation of the motor drive when the latch is in the coupled position, so as to prevent injury to the user of the tool. Such injury can occur during a chucking or dechucking operation when a user is gripping the adjustment sleeve and/or chuck body and the torque decoupler operates so this gripped part spins. This sensor constitutes an element of the tool that decreases its service life and increases its cost, so that this type of tool is only made in expensive professional-grade models.

### OBJECTS OF THE INVENTION

It is therefore an object of the present invention to provide an improved drill chuck.

Another object is the provision of such an improved drill chuck that overcomes the above-given disadvantages, in particular that has the advantages of the above-described chuck but that can be made less expensively while being no less safe to use.

### SUMMARY OF THE INVENTION

A chuck has according to the invention a drive shaft extending along and rotatable about an axis and a housing part adjacent the drive shaft and generally nonrotatable about the axis. A chuck body fixed to and rotatable with the shaft and formed with a plurality of guides holding respective jaws shiftable between closely spaced inner positions and widely spaced outer positions. An adjustment sleeve surrounding the body and coupled to the jaws is rotatable about the axis relative to the body to shift the jaws between their positions. A latch includes a coupling sleeve engaged between the housing part and the adjustment sleeve and shiftable between a coupled position for rotationally locking the adjustment sleeve to the housing part and a decoupled position for rotation about the axis of the adjustment sleeve relative to the housing part. In accordance with the invention a shield sleeve generally rotationally fixed on the housing part coaxially surrounds at least a portion of the adjustment sleeve and chuck body. In addition a torque decoupler is connected to the latch means for decoupling the latch from the chuck body when, in the coupled position, a torque exerted between the adjustment sleeve and the chuck body exceeds a predetermined limit.

With this system the parts of the chuck being rotated by the motor drive are at least partially shielded so that they cannot hurt the drill user. The adjustment sleeve does not need to be held during a chucking or dechucking operation and the shield according to the invention makes holding or even touching it more difficult or impossible.

According to the invention the shield sleeve extends generally a full axial length of the adjustment sleeve and chuck body and leaves at most only small outer end portions of the adjustment sleeve and chuck body exposed. Thus the user will be kept out of possible contact with any parts that might start rotating during a chucking or dechucking operation. Thus the only rotating part that is exposed is the very tip of the chuck into which the tool is fitted.

The shield sleeve according to the invention can include an inner part fixed on the housing part and an outer part extending to the end portions of the adjustment sleeve and chuck body and shiftable axially into a retracted position exposing more than these end portions. A spring between the inner and outer parts of the shield sleeve urges the outer part into an extended position only exposing at most the small outer end portions of the adjustment sleeve and chuck body. This makes it possible, if desired, to pull back the shield sleeve and manually open or close the chuck, as might be desired to chuck a particularly large or small tool. Such a system is used in conjuction with a standard spindle lock so that, to chuck or dechuck a tool manually, the user first operates the spindle lock to arrest the chuck body, then retracts the outer shield-sleeve part to expose the adjustment sleeve, and then rotates the adjustment sleeve in the appropriate direction.

It is also within the scope of the invention to provide an end cap fitted over the end portions of the adjustment sleeve and chuck body. This end cap is rotatable about the axis relative to the adjustment sleeve and/or to the chuck body. Such an end cap can engage radially outside over a front end of the shield sleeve. Such an end cap protects the user from rotating parts and can even be used during a chucking or dechucking operation. It furthermore prevents drilling particles from getting into the chuck.

In accordance with the invention a pair of axially offset stops are provided that are fixed axially relative to the chuck body. The coupling sleeve can shift between the stops on movement between the coupled position and the decoupled position. The housing part is tubular and surrounds the shaft, and the stops are radially outwardly open grooves formed in the housing part.

Furthermore according to the invention a grip ring is provided outside the shield sleeve. The shield sleeve is formed with at least one axially extending slot, and a connector extends radially through the slot between the grip ring and the coupling sleeve for actuation of the coupling sleeve by the grip ring. In addition the coupling sleeve is formed by a rear ring fixed to the housing part and a front ring. The front ring and the adjustment sleeve have axially interengageable formations that, when axially interengaged, rotationally lock the front ring to the adjustment sleeve. A torque decoupler is provided between the front and rear rings for rotationally coupling same to each other unless a torque between them exceeds a predetermined limit. This decoupler includes a plurality of coupling elements rotationally fixed to one of the rings, respective axially open seats partially receiving the coupling elements in the other of the rings, and a spring urging the rings toward each other so that when the predetermined torque limit is exceeded the elements are cammed out of the respective seats and the rings can rotate about the axis relative to each other. The seats have flat flanks, and the flanks of each seat extend at different angles to a plane perpendicular to the axis so that the predetermined torque limit is different depending on its rotational sense, typically more torque being permitted for dechucking a tool than for chucking it.

A spring urges the coupling sleeve into the decoupled position. Thus it is necessary for the user to actively hold the coupling sleeve in the coupled position so that, if anything happens and the chuck is released, the latch decouples.

### BRIEF DESCRIPTION OF THE DRAWING

The above and other objects, features, and advantages will become more readily apparent from the following description, it being understood that any feature described with reference to one embodiment of the invention can be used where possible with any other embodiment and that reference numerals or letters not specifically mentioned with reference to one figure but identical to those of another refer to structure that is functionally if not structurally identical. In the accompanying drawing:

FIG. 1 is an axial section through the chuck according to the invention, in the coupled position on the left and the decoupled position on the right;

FIG. 2 is a section taken along line II-II of FIG. 1;

FIG. 3 is a large-scale view of the detail indicated at III in FIG. 2;

FIGS. 4 and 5 are sections taken along respective lines IV-IV and V-V of FIG. 1;

FIGS. 6 and 7 are views like FIG. 1 of further chucks according to the invention; and

FIGS. 8 and 9 are sections taken along respective lines VIII-VIII and IX-IX of FIG. 7.

### SPECIFIC DESCRIPTION

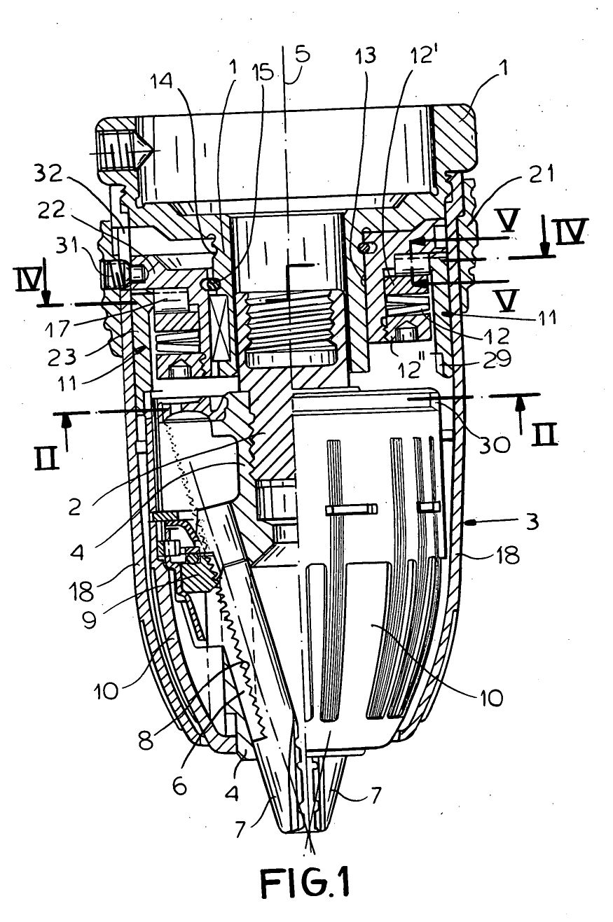

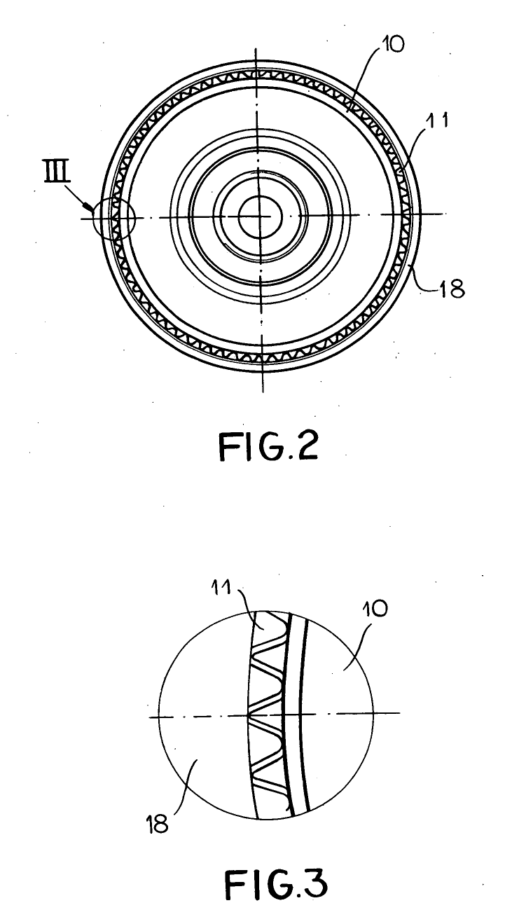

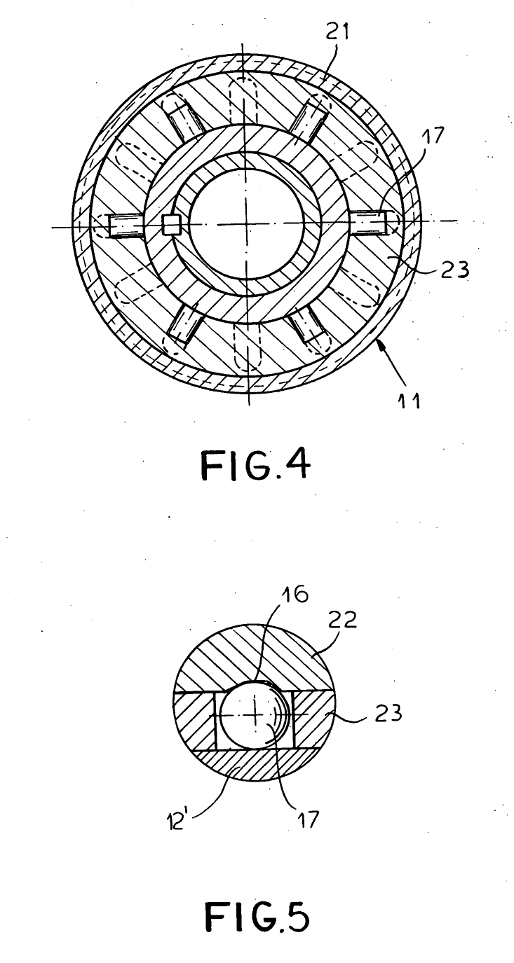

As seen in FIGS. 1 to 4, a nonrotating drill housing 1 centered on an axis 5 coaxially surrounds a shaft shown partially at 2 and rotatable by an unillustrated motor in the housing 1 about the axis 5. A chuck 3 carried on the housing 1 and shaft 2 comprises a chuck body 4 fixed to the shaft 2 and formed with a plurality of guides 6 in which jaws 7 can move axially forward and radially inward, and axially rearward and radially outward. Teeth 8 on radially outwardly directed edges of the jaws 7 mesh with an internally threaded ring 9 that can be rotated to synchronously move the jaws 7 inward and outward. A sleeve 10 coaxially and concentrically surrounding the ring 9 and extending axially-forward and rearward past it is rotationally coupled to this ring 9 so that it can be rotated and used to grip the jaws 7 on an unillustrated tool and to release them from the tool. Thus relative rotation between the adjustment sleeve 10 and the chuck body 4 radially and axially shifts the jaws 7. A sleeve 18 is fixed to the housing 1 and coaxially completely surrounds all but the very front end of the sleeve 10, body 4, and jaws 7, otherwise fully shielding and protecting the chuck 3.

A latch assembly 11 is provided that can, in a coupled position shown on the left in FIG. 1, secure the adjustment sleeve 10 against rotation relative to the housing 1 and, in a decoupled position shown on the right in FIG. 1, allow the adjustment sleeve 10 to rotate. The coupled position is used to tighten the jaws 7 on or loosen them from a tool and the decoupled position is used during drilling. Thus to chuck a tool, the user fits the tool in the front end of the chuck 3 between the spread jaws 7, shifts the assembly 11 into the coupled position, and operates the drill's drive to rotate the chuck body 4 and jaws 7 relative to the stationary sleeve 10 and slide the jaws 7 forward and inward. Opposite rotation of the body 4 in the coupled position is used to dechuck the tool.

The latch assembly 11 comprises an outer grip ring 21 that is the only part of the latch assembly 11 outside the shield sleeve 18, and rear and front internal rings 22 and 23. The outer grip ring 21 is secured by screws 31 that pass through slots 32 in the sleeve 18 with the rear ring 22. Thus the screws 31 and slots 32 rotationally couple the sleeve 18 to the rear ring 22 that in turn is rotationally coupled to the housing 1. An array of radially inwardly directed and axially extending teeth 29 at the front end of the front ring 23 mesh with a complementary array of radially outwardly directed teeth 30 on the rear end of the sleeve 10 in the coupled position. In the coupled position the assembly 11 is held by a spring ring 15 in a seat 13 on the housing 1 and in the decoupled position in a seat 14, the assembly 11 moving helically on shifting between these axial end positions.

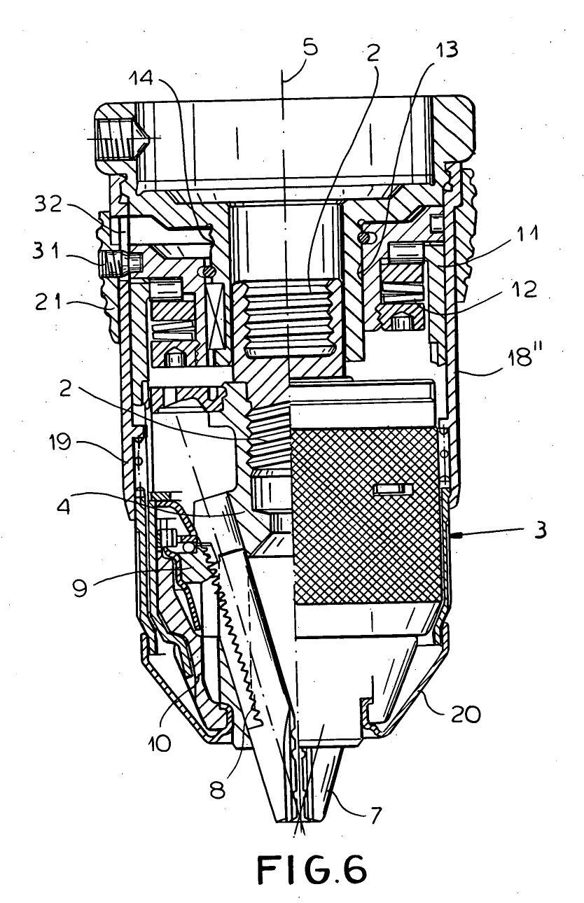

A torque decoupler formed by a stack of spring washers 12 between a pair of washers 12′ and 12″ serves to decouple the sleeve 10 from the housing 1 when the torque exerted between the sleeve 10 and the housing 1 exceeds a predetermined limit to prevent overload or damage to the parts. To this end the ring 23 is formed with radially inwardly open notches (see FIGS. 4 and 5) holding short cylindrical coupling elements 17 pressed by the springs 12 into seats 16 with differently angled flat flanks formed in the ring 22. When the latch 11 is in the coupled position, excessive torque between the housing 1 that is rotationally coupled to the ring 22 will compress the springs 12 and allow the elements 17 to shift out of the seats 16, allowing the rings 22 and 23, which are normally rotationally coupled to each other, to rotate about the axis 5 relative to each other.

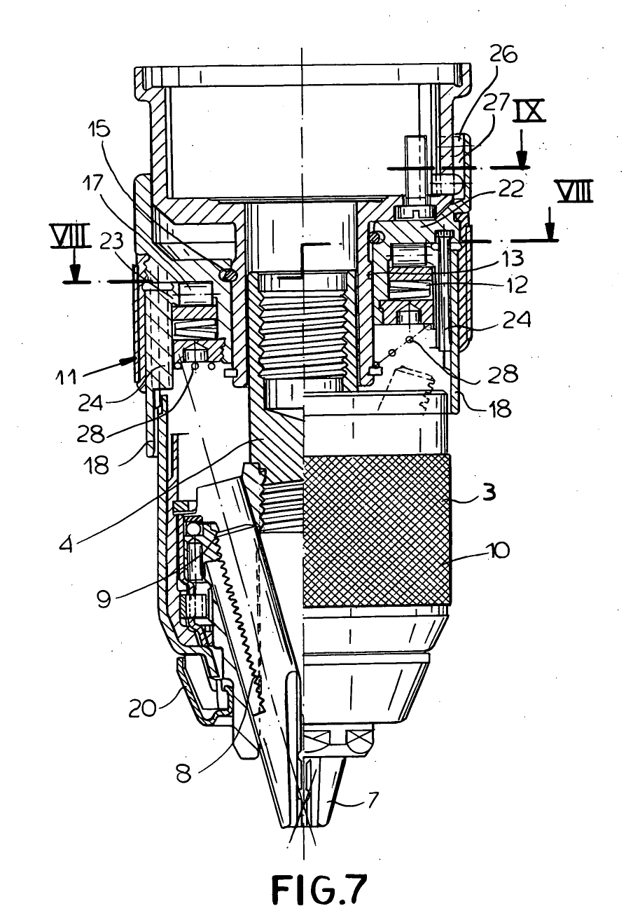

FIG. 6 shows an arrangement where two tubular shield-sleeve parts 18′ and 18″ are provided. The front part 18″ is axially shiftable relative to the rear part 18″, which is fixed on the housing 1, and a spring 19 urges the front part 18′ into the illustrated front position. Here also a sheet-metal cap ring 20 has a front inner end crimped around inside the front end of the sleeve 10 and a rear end fitting outside the front part 18′ in the front position thereof. This cap 20 is mounted rotatably, so that if during a drilling operation it bumps the workpiece, it can turn without damage to itself or the workpiece.

This arrangement makes it possible for a user of the chuck to slide back the front part 18′ and expose a front portion of the adjustment sleeve 10 so that same can be manually operated, once the shaft 2 is arrested by the standard spindle lock. This is very handy when, for instance, the chuck 3 needs to be moved quickly from a position with the jaws 7 at maximum spread to a closely spaced position for holding a small-gauge drill bit, or vice versa. Otherwise this embodiment works just like that of FIGS. 1-5.

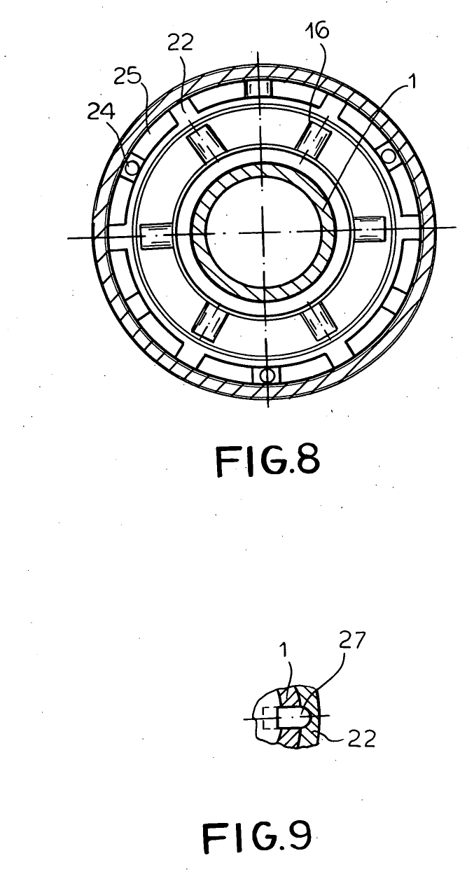

In FIGS. 7-9 pins 24 project between the rings 22 and 23 and ride on cams 25 so that when a torque limit is exceeded and the torque decoupler responds, the ring 22 is shifted out of the coupled-position seat 13. In addition here pins 27 set in the housing 1 engage in axially extending and radially inwardly open grooves 26 formed in the rear end of the ring 22 to rotationally solidly couple these parts 1 and 22 together. A spring 28 also urges the latch 11 into the decoupled position.

I claim:

1. A chuck comprising:
a drive shaft extending along and rotatable about an axis;
a housing part adjacent the drive shaft and generally nonrotatable about the axis;
a chuck body fixed to and rotatable with the shaft and formed with a plurality of guides;
respective jaws shiftable in the guides between closely spaced inner positions and widely spaced outer positions;
an adjustment sleeve surrounding the body, coupled to the jaws, and rotatable about the axis relative to the body to shift the jaws between their positions;
latch means including a coupling sleeve engaged between the housing part and the adjustment sleeve and shiftable between a coupled position for rotationally locking the adjustment sleeve to the housing part and a decoupled position for rotation about the axis of the adjustment sleeve relative to the housing part; and
a shield sleeve generally rotationally fixed on the housing part and coaxially surrounding at least a portion of the adjustment sleeve and chuck body.

2. The chuck defined in claim 1 further comprising
spring means connected to the latch means for decoupling the latch means from the chuck body when, in the coupled position, a torque exerted between the adjustment sleeve and the chuck body exceeds a predetermined limit.

3. The chuck defined in claim 1 wherein the shield sleeve extends generally a full axial length of the adjustment sleeve and chuck body and leaves at most only small outer and portions of the adjustment sleeve and chuck body exposed.

4. The chuck defined in claim 3 wherein the shield sleeve includes an inner part fixed on the housing part and an outer part extending to the end portions of the adjustment sleeve and chuck body and shiftable axially into a retracted position exposing more than these end portions.

5. The chuck defined in claim 4, further comprising
a spring between the inner and outer parts of the shield sleeve urging the outer part into an extended position only exposing at most the small outer and portions of the adjustment sleeve and chuck body.

6. The chuck defined in claim 3, further comprising
an end cap fitted over the end portions of the adjustment sleeve and chuck body.

7. The chuck defined in claim 6 wherein the end cap is rotatable about the axis relative to the adjustment sleeve.

8. The chuck defined in claim 6 wherein the end cap is rotatable about the axis relative to the chuck body.

9. The chuck defined in claim 6 wherein the end cap engages radially outside over a front end of the shield sleeve.

10. The chuck defined in claim 1, further comprising
a pair of axially offset steps fixed axially relative to the chuck body, the coupling sleeve shifting between the steps on movement between the coupled positions and the decoupled position.

11. The chuck defined in claim 10 wherein the housing part is tubular and surrounds the shaft, the stops being radially outwardly open grooves formed in the housing part.

12. The chuck defined in claim 1, further comprising
a grip ring outside the shield sleeve, the shield sleeve being formed with at least one axially extending slot; and
a connector extending radially through the slot between the grip ring and the coupling sleeve for actuation of the coupling sleeve by the grip ring.

13. The chuck defined in claim 1 wherein the coupling sleeve is formed by a rear ring fixed to the housing part and a front ring.

14. The chuck defined in claim 13 wherein the front ring and the adjustment sleeve have axially interchangeable formations that, when axially interengaged, rotationally lock the front ring to the adjustment sleeve.

15. The chuck defined in claim 13, further comprising
coupling means between the front end rear rings for rotationally coupling same to each other unless a torque between them exceeds a predetermined limit.

16. The chuck defined in claim 15 wherein the coupling means includes
a plurality of coupling elements rotationally fixed to one of the rings;
respective axially open seats partially receiving the coupling elements in the other of the rings; and
a spring urging the rings toward each other, whereby when the predetermined torque limit is exceeded the elements are cammed out of the respective seats and the rings can rotate about the axis relative to each other.

17. The chuck defined in claim 16 wherein the seats have flat flanks.

18. The chuck defined in claim 17 wherein the flanks of each seat extend at different angles to a plane perpendicular to the axis, whereby the predetermined torque limit is different depending on its rotational sense.

19. The chuck defined in claim 1, further comprising
a spring urging the coupling sleeve into the decoupled position.

20. The chuck defined in claim 1 further comprising an axially extending groove and a radially projecting pin rotationally coupling the coupling sleeve to the housing part.
